(19) United States
(12) Patent Application Publication
(10) Pub. No.: US 2018/0130005 A1
(43) Pub. Date: May 10, 2018

(54) PERSONNEL MANAGEMENT SYSTEM

(71) Applicant: DISCO CORPORATION, Tokyo (JP)

(72) Inventor: Kazuma Sekiya, Tokyo (JP)

(21) Appl. No.: 15/796,331

(22) Filed: Oct. 27, 2017

(30) Foreign Application Priority Data
Nov. 8, 2016 (JP) 2016-218279

(51) Int. Cl. G06Q 10/06

(52) U.S. Cl. CPC G06Q 10/06398

(57) ABSTRACT

A personnel management system has an account storage unit configured to store a balance of a department account and a balance of a personal account of an employee belonging to and linked to the department. A controller is configured to manage the balance of each account, and a terminal for entering information. The controller has a point setting block configured to set and store points in accordance with a task, a point exchange block configured to pay the points set in accordance with the task from a department account which orders the task, or a personal account who orders the task, to some department account which contracts the task, or a personal account of an employee who contracts the task. A personal evaluation block is configured to evaluate an employee on the basis of a balance of a personal account every predetermined period.

### BACKGROUND OF THE INVENTION

### Field of the Invention

The present invention relates to a personnel management system for use in the evaluation of employees and the departments to which these employees belong in corporations and other organizations.

### Description of the Related Art

It is important for corporations and other organizations to enhance the productivity by making the most of the capacities of employees and other human resources so as to achieve profit maximization. In order to achieve this objective, it is required to correctly evaluate the capacities of employees and other human resources and the contribution thereof to the corporations. For the realization of this purpose, it is a general practice to execute the personnel evaluation on subordinates by employee managing superiors (refer to Japanese Patent Laid-open No. 2006-185080, for example).

On the other hand, there are positions and departments that do not directly lead to results like middle management and management departments and the evaluation thereof executed by the positions (executives, chiefs of departments, etc.) who manage the positions and departments concerned presents problems that such evaluations are often executed on the basis of the subjective judgement by the evaluators, thereby increasing the discrepancies in recognition between the evaluator and the evaluated (departments).

In addition, if superiors give detailed task instructions and manages overtime work in a situation where there is no proper evaluation provided to subordinates, the excess management by the superiors possibly deteriorates the development performance, processing performance, self-management performance, motivations, and so on of the subordinates, thereby eventually hampering the development of the corporations.

In order to solve the above-mentioned problems, the applicant hereof proposes a system in which points (virtual currency) corresponding to a task requested or contracted by employees in a corporation are set to the task concerned and these points are transferred between the accounts of the employees who are contractor and contractee so as to quantify the amount of the task concerned and a value thereof, thereby utilizing the increments of the accounts that manage these points for the personnel evaluation in a predetermined period (refer to Japanese Patent Laid-open No. 2016-126586, for example).

### SUMMARY OF THE INVENTION

According to the proposition described in Japanese Patent Laid-open No. 2016-126586, task results of employees can be quantified to a certain degree, but it is not sufficient to execute the evaluation of a department itself to which an employee belongs or the evaluation including a task with external organizations, leading to the unfairness in personnel evaluation and the like. Therefore, further improvements of personnel management systems have been sought that lead to the enhancement in the development performance, processing performance, self-management performance, and motivation of each employee.

Therefore, one of the objectives of the present invention is to provide a personnel management system by which task results of each employee and the task results of a department to which the employee belongs can be quantified so as to execute the evaluations of the employee and the department to which the employee belongs by use of parameters high in objectivity including the task results of tasks with external organizations.

In accordance with an aspect of the present invention, there is provided a personnel management system including a computer. This personnel management system has account storage means configured to store a department account of a department and a personal account of an employee belonging to and linked to the department, control means configured to manage a balance of each account stored in the account storage means, and terminal means connected to the control means. In this configuration, the control means has a point setting block configured to set and store points in accordance with a task, a point exchange block configured to pay the points set in accordance with the task from a department account of a department which orders the task or a personal account of an employee who orders the task to a department account of a department which contracts the task or a personal account of an employee who contracts the task, an external expenditure management block configured to subtract points in accordance with an amount of payment from a predetermined account of a department that pays money to an external organization, an external income management block configured to pay points in accordance with an amount of reception to an account of a department that receives money paid from an external organization, a department evaluation block configured to evaluate a department on the basis of points computed by dividing a balance of a department account by the number of persons belonging to the department every predetermined period, and a personal evaluation block configured to evaluate an employee on the basis of a balance of a personal account of the employee every predetermined period. The terminal means is configured to enter at least an ordered task or a contracted task and points set in accordance therewith.

Preferably, if points are paid from the department account or a personal account of an employee belonging to the department to a personal account of an employee belonging to another department, the control means adds the points also to a department account of the department with which the personal account of the employee to which the points are paid is linked; if points are paid from a personal account of an employee belonging to a department to a personal account of an employee belonging to another department, the control means subtracts the points also from a department account of the department with which the paying personal account is linked; and if point exchange takes place between personal accounts of employees belonging to a department or between a personal account of an employee belonging to a department and a department account, the control means does not change the department account of the department. Further, preferably, the points are virtual currency. It should be noted that, in the present invention, phrase “points are virtual currency” denotes that a corporation manages the points as the expenditure and income of a department and an employee such that these points provide the intermediary in the ordering and contracting tasks in the corporation.

According to the present invention, the evaluation of a department and an employee is done with points that are set in accordance with the load, the degree of difficulty, and so on of each task to be executed by the employee, so that promotion and pay raise are done on the basis of quantified values, thereby preventing the unfairness in the evaluation of each employee. This setup enhances the motivation, development performance, task processing performance and self-management performance of each employee, makes unnecessary the excess management by superiors, and boosts the development of the corporation.

In addition, the points accumulated in the personal account of each employee become the points of the department to which the employee belongs, so that the task results of each employee lead to the enhancement in the evaluation of the department and the employee's labor is evaluated also as the contribution to the department, which in turn is reflected upon the distribution ratios of bonus and so on. Further, not only the evaluation of each employee but also the evaluation of the department can be objectively executed by the common system, thereby leading to the competition between departments so as to eventually activate the corporation.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a block diagram illustrating an overall configuration of a personnel management system configured on the basis of the present invention;

FIG. 2 is a block diagram illustrating details of a management server;

FIG. 3 is a diagram illustrating a flow of a task executed by use of the personnel management system of the present invention; and

FIGS. 4A and 4B are diagrams illustrating examples of balances of accounts aggregated by the personnel management system of the present invention.

### DETAILED DESCRIPTION OF THE PREFERRED EMBODIMENT

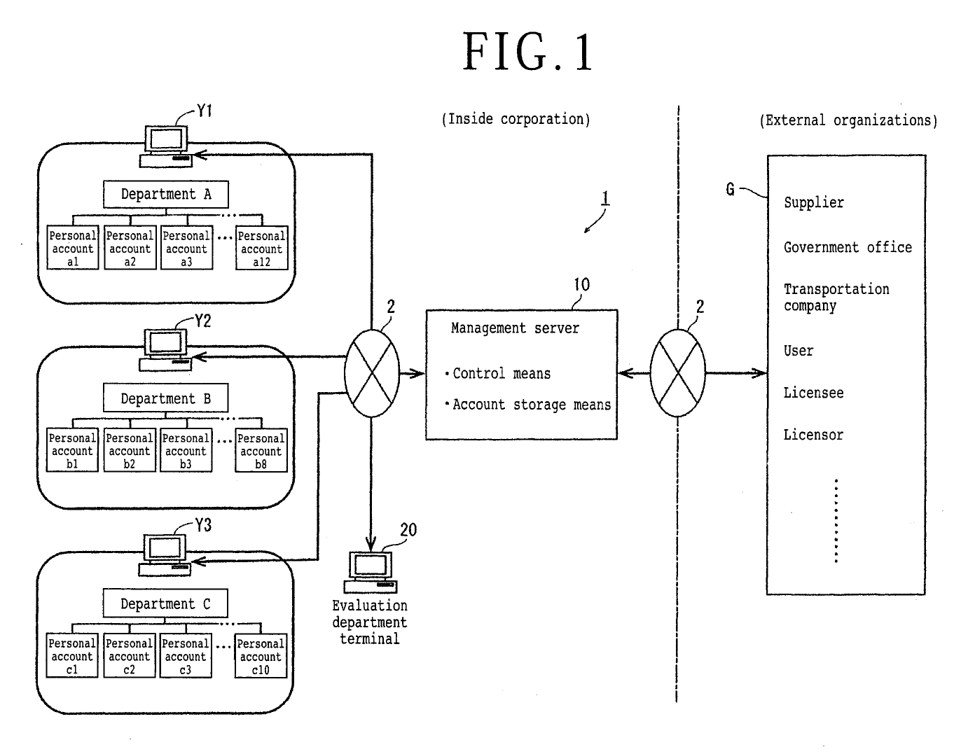

The following describes in more detail a personnel management system configured on the basis of the present invention with reference to attached diagrams. FIG. 1 schematically depicts one example of the personnel management system configured on the basis of the present invention. A personnel management system 1 of the present embodiment has terminal means Y1 through Y3 respectively allocated to departments (departments A through C), a management server 10 to which the terminal means Y1 through Y3 are connected, an evaluation department terminal 20, and a communication network 2 as connection means for interconnecting the terminal means Y1 through Y3, the evaluation department terminal 20, and the management server 10. It should be noted that, in the drawings, only three departments to be evaluated are depicted for the convenience of description but the number of departments is not limited to three; it is also practicable for a corporation concerned to be organized by two or more departments. In addition, in FIG. 1, the left side of a dashed line depicts the inside of a corporation, while the right side of the dashed line depicts external organizations that are different in accounting from this corporation.

The management server 10 is configured by a computer; it is desirable for this computer to have a high-speed central processing unit (CPU) and mass storage means (a main storage apparatus such as random access memory (RAM) and read only memory (ROM) and an auxiliary storage apparatus such as a magnetic disc or the like). However, the computer is not limited to this configuration. The management server 10 has control means, account storage means, and so on, the details of which will be described later.

In the present embodiment, an example in which the terminal means Y1 through Y3 are arranged to the respective departments is described for the convenience of description; however, each department need not always have one terminal means but it is also practicable that one terminal means may be allocated to one employee. The terminal means Y1 through Y3 may each use a personal computer; however, it is also practicable for each of the terminal means Y1 through Y3 to use any terminal that has functions allowing the input of task information to be described later and transmitting this information to the management server 10, such as use of a portable tablet terminal.

For the communication network 2, a generally known Internet line can be used. Configuring the communication network 2 by assuming the use of the Internet line makes it practicable to access the management server 10 to enter necessary information even in a situation where the terminal means Y1 through Y3 are outside the corporation concerned. It should be noted that the present invention is not limited to this configuration; it is also practicable to configure the communication network 2 only with a local area network (LAN) restricted to inside the corporation or with a combination of the Internet line and the LAN inside the corporation. That is, any networks may be employed that allow the interconnection between the terminal means Y1 through Y3 and the management server 10 in a wired manner or a wireless manner.

As depicted, the departments A through C are each linked with the employees belonging thereto (employees a1 through a12, b1 through b8, and c1 through c10), and the departments A through C and the employees to be evaluated are grouped. It should be noted that, a “department” in the present invention may be any organization to which two or more employees belong that is not limited by formality or title, including a department, a division, a section, a team, a group, and the like.

The management server 10 is connected through the communication network 2 with an external organization G (suppliers, government offices, transportation companies, users, licensors, licensees, and so on) with which there is supposed to be money transfer. The management server 10 is configured to manage the information about a task between the corporation and the external organization G and the amount of payment for the task.

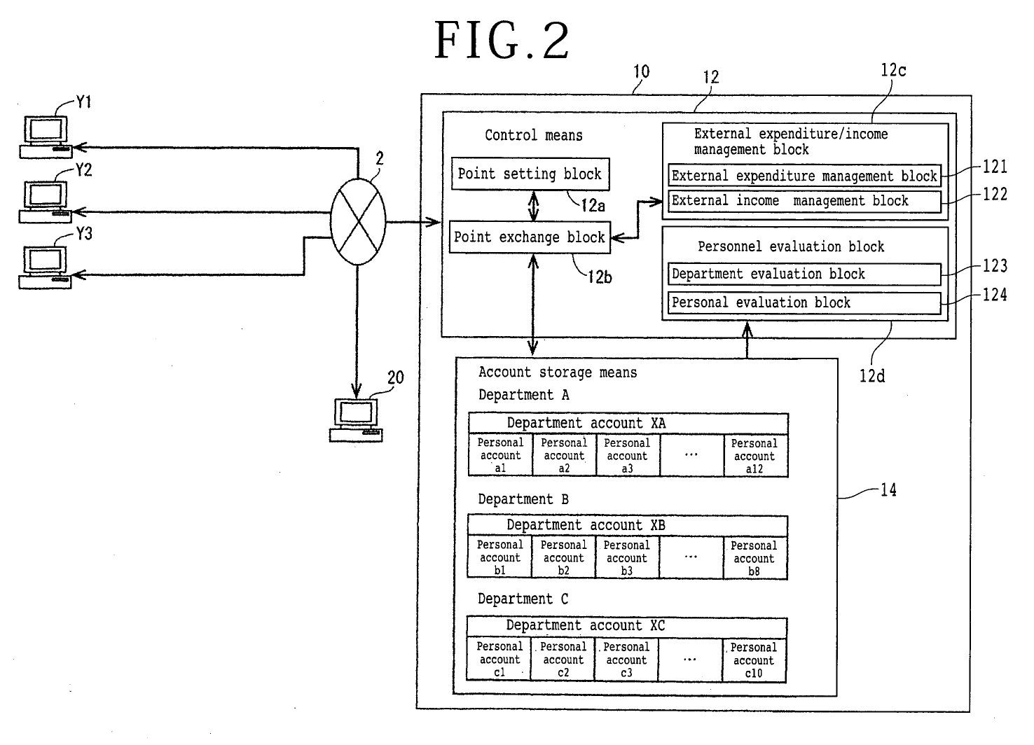

The following describes in more detail the management server 10 of the personnel management system 1 in the present embodiment with reference to FIG. 2. The management server 10 at least has control means 12 and account storage means 14. The control means 12 includes a point setting block 12a, a point exchange block 12b, an external expenditure/income management block 12c, and a personnel evaluation block 12d that are configured on the basis of the present invention. The external expenditure/income management block 12c includes an external expenditure management block 121 and an external income management block 122. The personnel evaluation block 12d includes a department evaluation block 123 and a personal evaluation block 124. The point setting block 12a, the point exchange block 12b, the external expenditure/income management block 12c, and the personnel evaluation block 12d that make up the control means 12 are each configured by a computer program that is stored in a memory of the management server 10 so as to appropriately execute allocated processing on the basis of the information entered from the terminal means Y1 through Y3. Further, the account storage means 14 includes an auxiliary storage apparatus such as a magnetic disc and is managed by the point exchange block 12b.

The personnel evaluation block 12d executes department evaluation and personal evaluation by referencing the information of the point balance of each account stored in the account storage means 14, and the information of the personnel evaluation obtained by the execution of the personnel evaluation block 12d is set such that, among the terminal means accessing the management server 10, this information can be accessed only from the evaluation department terminal 20 identified that a person in responsible for personnel evaluation is accessing the management server 10.

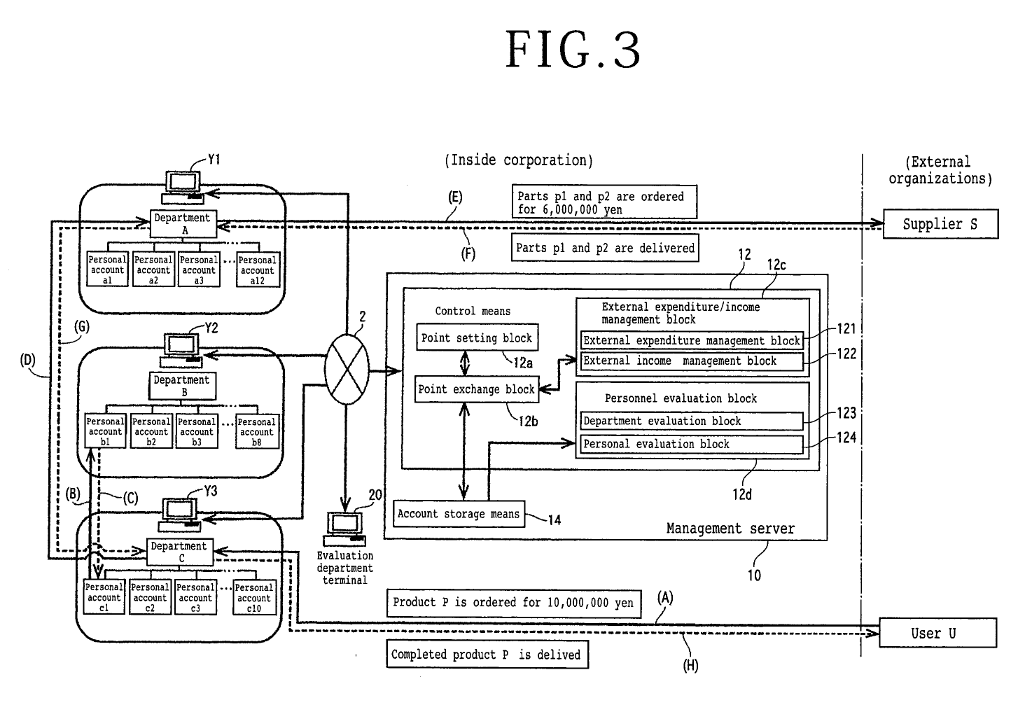

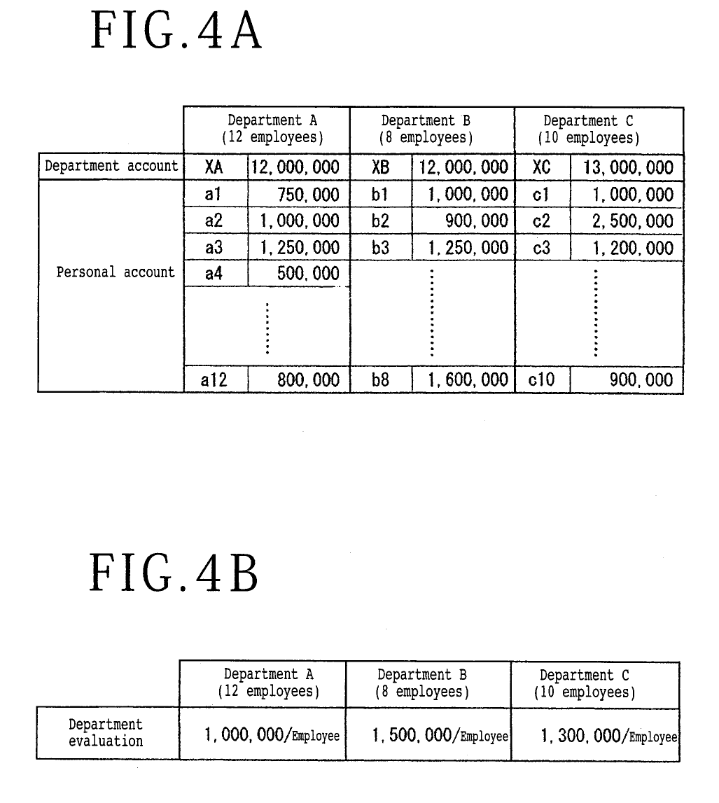

The personnel management system 1 according to the present invention is generally configured as described above. The following describes how points circulating inside the personnel management system 1 are accumulated in the account of each department with reference to FIG. 3 for a task flow and FIGS. 4A and 4B for an account configuration.

The accounts of departments handled by the present invention are configured as depicted in FIG. 4A, for example; namely, the accounts of the department A include a department account XA for managing the points of the department A and personal accounts a1 through a12 allocated to the employees (a total of 12 persons) linked to the department A so as to manage the points to be caused by the personal execution of a task allocated to these employees.

Like the department A described above, the accounts of the department B include a department account XB for managing the points of the department B and personal accounts b1 through b8 allocated to the employees (a total of eight persons) linked to the department B so as to manage the points to be caused by the personal execution of a task allocated to these employees. Similarly, the accounts of the department C include a department account XC for managing the points of the department C and personal accounts c1 through c10 allocated to the employees (a total of ten persons) linked to the department C so as to manage the points to be caused by the personal execution of a task allocated to these employees. It should be noted here that a “department account” is an account for managing the points paid to a department and an employee belonging to the department from outside of the department and the points paid from a department and an employee belonging to the department to an external department or a personal account. A “personal account” is an account for managing points exchanged in association with a task requested by an employee or contracted by an employee. To be more specific, if points are paid from a department account or a personal account of an employee to a personal account of an employee belonging to another department, the points are added to the personal account of the paid employee and, at the same time, the same number of points are also added to the department account of the department to which the personal account of the paid employee is linked. Further, if points are paid from a personal account of an employee belonging to a department to a personal account of an employee belonging to another department, the points are subtracted from the personal account of the paying employee and, at the same time, these points are also subtracted from the department account of the department to which the personal account of the paying employee is linked. Then, if a point exchange occurs between the personal accounts of the employees belonging to a department or between a personal account of an employee belonging to a department and a department account, there is no change in the department account of the department concerned.

The information of the balance of each account described above is stored in the account storage means 14 arranged in the management server 10. In the beginning of a predetermined period to be personnel-evaluated, for example, at the beginning of a new fiscal year, the points in the department accounts XA, XB, and XC of the departments and the personal accounts a1 through a12, b1 through b8, and c1 through c10 are all set to zero. Then, entering, through the terminal means Y1 through Y3 allocated to the departments A through C, a task to be executed by each department and each employee, points to be set in accordance with the task, information of the completion of each task, and the like changes the point balance of each of the accounts. The following more particularly describes a process in which the point balance of each account is increased or decreased from a time at which a task actually occurs.

First, assume that a user U classified as an external organization G places an order to the department C in charge of business for the purchase of a product P (equivalent to 10,000,000 yen) made by the corporation concerned (refer to (A) in FIG. 3). Since this task provides an income from the external organization G, the employee c1 belonging to the department C allocated with this task accesses the external income management block 122 of the external expenditure/income management block 12c of the control means 12 arranged in the management server 10 from the terminal means Y3 and enters information that the department C has accepted the order for the product P for 10,000,000 yen and this task has been allocated to the employee c1 for 1,000,000 points.

Since the above-mentioned product P requires customization of the base product in accordance with the required specifications of the user U, the employee c1 requests the employee b1 of the department B in charge of design for the customization based on the required specifications of the user U (refer to (B) in FIG. 3). At this moment, points in accordance with a task related with the design concerned are set between the employee c1 and the employee b1 by considering a load and a time necessary for the execution of the task. In the present embodiment, the number of points in accordance with this design task is set to 1,000,000 points and the contracting employee b1 accesses the control means 12 of the management server 10 from the terminal means Y2 of the belonging department B and enters the information of the requesting department, the contents of this task, and the number of points corresponding thereto into the point setting block 12a.

The employee b1 executes customized design in accordance with the required specifications and completes the above-mentioned accepted design task. The employee b1 sends a report that the design drawings of the product P have been completed to the employee c1 (refer to (C) in FIG. 3) and, if the report is officially accepted, accesses the control means 12 from the terminal means Y2 so as to enter the information that the task executed by the employee b1 has been completed. Since this task is a task contracted from the department C, the point exchange block 12b of the control means 12 executes a point exchange for paying 1,000,000 points from the department account XC of the department C to the personal account b1 of the employee b1. It should be noted that, in the present embodiment, the points are paid from the department account XC directly to the personal account b1 but this is not limitative; it is also practicable to formally transfer 1,000,000 points from the department account XC to the personal account c1 of the employee in charge and then to the personal account b1 of the department B via the personal account c1. At this point of time, the department accounts XB and XC of the department B and the department C and the personal account b1 of the employee b1 change as follows:

### Department B

Department account XB=1,000,000 points

Personal account b1=1,000,000 points

### Department C

Department account XC=−1,000,000 points

To be more specific, if points are paid from a department account or a personal account of an employee to a personal account of an employee belonging to another department by the function of the “point exchange block” of the present invention, the points are added to the personal account of the paid employee and, at the same time, the same number of points are added to the department account of the department to which this employee belongs. Therefore, 1,000,000 points are paid from the department account XC of the department C to the personal account b1 of the employee b1 of another department B and, at the same time, the same number of points are also paid to the department account XB.

On the basis of the completed design drawings, the employee c1 requests the department A in charge of manufacture for the manufacture of the product P. The design drawings drafted by the employee b1 are sent to the department A in charge of manufacture, upon which 8,000,000 points are set by considering a load of a manufacture task of the product P contracted by the department A and the manufacture cost such as a parts price necessary for manufacture and then an order is placed for the product P (refer to (D) in FIG. 3). The manufacture of the product P is done by two or more employees belonging to the department A and the order of the product P is placed not to the individual employees but to the department A. In the department A, four employees a1 through a4 are assigned for those in charge of the manufacture of the product P and 500,000 points are set to each of these employees in accordance with the task concerned. Then, each of these employees accesses the management server 10 from the terminal means Y1 of the department A so as to enter into the point setting block 12a the information that the department A has accepted from the department C the order for the manufacture of the product P for 8,000,000 points, this manufacture task has been assigned to the employees a1 through a4 in the department A, and each of the employees al through a4 has contracted the task associated with the manufacture for 500,000 points. It should be noted that, in the present embodiment, the manufacture of the product P is requested from the department C to the department A; however, it is also practicable to request the department B in charge of design for the task including the manufacture and the department A is requested from the department B for the manufacture of the product P, for example.

In the department A, in manufacturing the product P, it is necessary to purchase parts p1 and p2 from an outside supplier, so that an order of these necessary parts p1 and p2 is placed to a supplier S as an external organization G for 6,000,000 yen (refer to (E) in FIG. 3). Since this task involves an expenditure to the external organization G, the contents of the task and an amount of money actually slated to be paid are registered in the external expenditure management block 121 of the external expenditure/income management block 12c of the control means 12. It should be noted that, in the above-mentioned description, only the parts p1 and p2 are ordered for the convenience of description; actually, however, orders for more parts are supposed to be placed to two or more suppliers.

When the parts p1 and p2 ordered to the supplier S are delivered to the department A (refer to (F) in FIG. 3), 6,000,000 yen corresponding to the parts p1 and p2 is paid from the department A to the supplier S. When the information that the parts p1 and p2 have been delivered and the amount of money for the delivered parts p1 and p2 has been paid is entered from the terminal means Y1 into the control means 12, the external expenditure management block 121 is executed so as to transmit this information to the point exchange block 12b that manages the points of the account storage means 14, upon which the number of points=6,000,000 points equivalent to the amount of money are subtracted from the department account XA of the department A. At this point of time, the balances of the department accounts XA, XB, and XC of the departments A through C and the personal account b1 of the employee are as follows:

### Department A

Department account XA=−6,000,000 points

### Department B

Department account XB=1,000,000 points

Personal account b1=1,000,000 points

### Department C

Department account XC=−1,000,000 points

In the department A, the employees a1 through a4 in charge of the manufacture of the product P execute the assigned task, assemble and complete the product P, and deliver the completed product P to the department C that is the point of contact for the user U (refer to (G) in FIG. 3). It should be noted that, since the departments A and C are in the same corporation, the term “delivery” does not always denote the physical movement of the product P to the department C; it is also practicable to store the product P inside the department A or at a predetermined finished product storage space in the corporation and send a report that the product P has been completed to the department C, for example. Then, after the delivery of the product P to the department C, the information that the manufacture task of the product P has been completed is entered from the terminal means Y1 of the department A in charge of the manufacture into the control means 12. Consequently, on the basis of the points set to the point setting block 12a, 8,000,000 points are paid from the department account XC of the department C to the department account XA of the department A and, at the same time, 500,000 points are paid from the department account XA to each of the personal accounts a1 through a4 of the employees a1 through a4 in charge of the manufacture belonging to the department A. Here, in the control means 12 configured on the basis of the present invention, if points are paid from a department account to a personal account of an employee belonging to that department, there occurs no change in the department account. Consequently, the balances of the accounts are as follows:

### Department A

Department account XA=2,000,000 points

Personal account a1=500,000 points

Personal account a2=500,000 points

Personal account a3=500,000 points

Personal account a4=500,000 points

### Department B

Department account XB=1,000,000 points

Personal account b1=1,000,000 points

### Department C

Department account XC=−9,000,000 points

Personal account c1=−9,000,000 points

To be more specific about changes in the account balances mentioned above, the 8,000,000 points paid from the department account XC of the department C to the department A are paid to the department account XA of the department A and the balance of the department account XA becomes 2,000,000 points from −6,000,000. Then, 500,000 points are paid from the department account XA to each of the personal accounts a1 through a4 of the employees a1 through a4 in charge of the manufacture of the product P. Here, as described above, the department account is not changed in the point exchange in the same department, so that the department account XA of the department A remains at 2,000,000 points without change.

Upon completion of the product P, the department C delivers the product P to the user U (refer to (H) in FIG. 3). Receiving the product P, the user U pays 10,000,000 yen to the department C for the product P. The employee c1 enters the information about the delivery completion and payment completion from the terminal means Y3. The 10,000,000 yen paid by the user U is the real amount of money paid from the external organization G. Executing of the external income management block 122 depicted in FIG. 3 transmits the information that 10,000,000 yen has been paid from the user U to the point exchange block 12b, upon which 10,000,000 points equivalent to the 10,000,000 yen are paid to the department account XC of the department C. At the same time, upon completion of the task concerned, 1,000,000 points are paid to the personal account c1 of the employee c1 in charge of the task concerned in the department C. Thus, the task is executed in which the product P is ordered by the user U as the external organization G and, by the cooperation between the departments in the corporation, the product P is completed to be delivered to the user U. Consequently, the balances of the accounts are as follows:

### Department A

Department account XA=2,000,000 points

Personal account a1=500,000 points

Personal account a2=500,000 points

Personal account a3=500,000 points

Personal account a4=500,000 points

### Department B

Department account XB=1,000,000 points

Personal account b1=1,000,000 points

### Department C

Department account XC=1,000,000 points

Personal account c1=1,000,000 points

It should be noted that the payment and exchange of points described above are illustrative only; namely, the destination of payment, the number of points, and point exchange timing in the payment of points in the execution of a task are appropriately adjusted between the departments and the employees. For example, in the above-mentioned embodiment, the employee b1 of the department B is directly requested for the customization design of the product P; it is also practicable to request not one employee b1 but the department B for the execution of a task so as to divide the necessary task among proper persons in the department B. In this case, the points providing the payment for the customization design are paid from the department account XC of the department C to the department account XB of the department B and the number of points corresponding to the task are paid from the department account XB to the personal account b1.

In the above-mentioned embodiment, the balance of each account sometimes becomes negative in the process up to the completion of a task. Therefore, in the execution of the evaluation half way through this process, if the evaluation is executed on the basis of the balance of each account, an unfairness is supposed to occur in the results of the evaluation although each employee is executing a task without problem. Consequently, in order to prevent this problem from happening, a configuration for playing the role such as a virtual “bank” in which the points to be accumulated from the occurrence of a task to the completion thereof are temporarily paid in advance can be arranged on the point exchange block. With the present embodiment, the payment from the department account XC of the department C to the personal account b1 of the employee b1 of the department B, the payment of points to the department account XA of the department A in charge of the manufacture of the product P, or the expenditure of points involved in the payment of the amount of money from the department A to the suppler S as the external organization G may be executed in advance by this “bank” and, upon the payment of the points to each account with the completion of each task, the points paid in advance may be returned to this “bank.” This arrangement can prevent a situation in which an unfair, negative evaluation is made due to evaluation timing regardless that the task is being executed without trouble and delay.

As described above, the execution of tasks contracted by departments and employees increases or decreases the balances of the points in the department accounts and the personal accounts. The following specifically describes, with reference to FIGS. 4A and 4B, an operation of the personnel evaluation block 12d that executes personnel evaluation by use of these account point balances.

FIG. 4A depicts the point balances of the accounts accumulated by executing tasks for a predetermined period, six months for example. It should be noted that FIG. 4A does not depict the balances of all personal accounts, some of which are omitted. Here, as depicted in FIG. 4A, it can be understood that the balance of the department account XA of the department A is 12,000,000 points, the personal account having the highest balance is the personal account a3 that holds 1,250,000 points, and the personal account having the lowest balance is the personal account a4 that holds 500,000 points.

Likewise, it can be understood that the balance of the department account XB of the department B is 12,000,000 points, the personal account having the highest balance is the personal account b8 that holds 1,600,000 points, and the personal account having the lowest balance is the personal account b2 that holds 900,000 points; like the department A, the balance of the department account XB is 12,000,000 points, the department unique balance c0 of the department C is 0 point, the personal account having the highest balance is the personal account c2 that holds 2,500,000 points, the personal account having the lowest balance is the personal account c10 that holds 900,000 points, and the balance of the department account XC is 13,000,000 points. It should be noted that, as described above, the balance of each account does not simply increase as a task is executed; namely, the balance of each account increases or decreases as the ordering and acceptance of tasks are mutually executed. Further, it is clear as described above that each department account includes the points directly paid to the department account in addition to the points in the personal accounts of the employees belonging to that department; namely, the balance of the department account is not always the adding-up of the balances of the personal accounts in that department.

The following describes the functions of the department evaluation block 123 and the personal evaluation block 124 of the personnel evaluation block 12d. The department evaluation block 123 divides the balances of the department accounts XA through XC of the departments A through C at the end of a predetermined period by the number of persons belonging to the department concerned (the department A=12 persons, the department B=eight persons, and the department C=ten persons) so as to execute the evaluation of the department in the predetermined period. This computes the number of points per person of each department as depicted in FIG. 4B. On the basis of the obtained values, the evaluation of the departments A through C is executed. In the example depicted in FIG. 4B, the department that gets the highest evaluation is the department B and the department that gets the lowest evaluation is the department A. Thus, the department account that has a high balance does not always simply lead to a high evaluation; namely, a department that is high in the number of points per person is highly evaluated as the department efficiently contributing to the corporate business results.

By contrast, personal evaluations are executed on the basis of the balance of the points in a personal account by executing the personal evaluation block 124. As clearly seen from FIG. 4A, the employee having the highest balance is the employee c2 belonging to the department C and the employee having the lowest balance is the employee a4 belonging to the department A. Then, an evaluation is executed on the basis of the above-mentioned department evaluation and the balance of the points in the personal account concerned and the computation of the amount of bonus for example is executed on the basis of the obtained evaluation. It should be noted that the amount of bonus need not always be computed on the basis of only the balance of the points concerned; namely, the amount of bonus may be computed by adding, as part of bonus, the amount computed by the evaluation based on the above-mentioned account balance to a basic part, a basic pay×two months for example, to be paid using a common computation equation to all employees. Further, the value of the balance of a personal account may be used as it is as an evaluation; however, it is also practicable to set two or more point values providing threshold values so as to make comparison between the balances of personal accounts and the threshold values, thereby providing five-step evaluations for example. In addition, if the contents of tasks vary to a large extent between the departments and therefore it is not desired to uniformly evaluate the employees throughout the departments on the basis of the balances of the personal accounts, only the evaluation of each employee in each department may be executed on the basis of the point balance of each personal account so as to use this evaluation as a promotion evaluation, and the capital of the bonus distributed to each department on the basis of the department evaluation may be distributed on the basis of this personal account evaluation.

As described above, in the present invention, if real currency is paid to an external organization or real currency is obtained from an external organization as an income, the points related with the amount of the real currency, the equivalent number of points for example, are subtracted or added from or to each department account or each personal account. Provision of this arrangement ensures that the points in the personnel management system according to the present invention have a value of circulating inside each corporation as virtual currency.

While the preferred embodiment of the present invention has been described using specific terms, such description is for illustrative purpose only, and it is to be understood by those skilled in the art that changes and variations may be made without departing from the technical scope of the present invention. For example, for the points circulating in the personnel management system 1 described above, a value equivalent to really circulating currency may be used without change or these points may be unique points contrived as virtual currency that is separated from the really circulating currency. It should be noted that circulating a value equivalent to the really circulating currency as points is desirable because effects can be obtained by which the contribution of each employee or each department to the corporation is clearly understood. In addition, circulating the points equivalent to the real currency allows efficient cost judgement whether to outsource tasks or have departments inside the corporation handle tasks, thereby cutting the wasted cost.

Further, in the point setting block 12a of the control means 12 of the present embodiment, the amount of points to be exchanged is adjusted and determined between the contractor and contractee by considering the degree of difficulty of a task concerned, the necessary manpower, and the period of execution every time a task occurs. This makes it clear that a department or an employee who executes a task efficiently can undertake a task for the smaller number of points, thereby facilitating the selection of a department or an employee who is excellent in the cost performance related with the execution of an ordered task. On the other hand, if a task to be ordered is a regular task or a combination of regular tasks, an amount of points suitable for that task may be predetermined by a point table or the like, thereby making it practicable to automatically set the points only by entering the type of the task from terminal means. This arrangement can prevent errors in point setting and problems of causing unfairness such as the difference of necessary points between employees to whom a task is ordered regardless that the task is a regular task.

In the description of the embodiment mentioned above, for an example of the expenditure and income of money with the external organization G, the transaction with the user U and the supplier S is described; however, various other examples are assumed for the expenditure and income with the external organization G in corporate activities. For example, in a department that handles patent applications in the corporation, the expenditure for the external organization G, the Patent Agency for example, often takes place in the processing of executing patent application tasks. In addition, if the transportation related with the delivery of a product is contracted out to an external transportation company, the transportation cost is managed as the expenditure to the external organization G (the transportation company). Further, in the case of a department in charge of managing the real estates owned by the corporation, the tenant fees from the tenants of these real estates can be managed as the income from the external organization G. Then, the points in accordance with these expenditure and income are subtracted from or added to the department account of the department in charge of the tasks concerned.

In the present embodiment described above, an example is described in which the control means 12 and the account storage means 14 are arranged in the management server 10 inside a corporation; however, locations at which the control means 12 and the account storage means 14 are really arranged are not especially limited. These days, in order to avoid the loss of information caused by disasters and so on, servers are arranged outside a corporation in a distributed manner. In this case, the control means 12 and the account storage means 14 may be registered in the server arranged outside the corporation via the communication network 2, thereby configuring the personnel management system.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A personnel management system including a computer, the personnel management system comprising:
account storage means configured to store a department account of a department and a personal account of an employee belonging to and linked to the department;
control means configured to manage a balance of each account stored in the account storage means; and
terminal means connected to the control means;
wherein
the control means has
a point setting block configured to set and store points in accordance with a task, a point exchange block configured to pay the points set in accordance with the task from one of a department account of an department which orders the task and a personal account of an employee who orders the task to one of a department account of a department which contracts the task and a personal account of an employee who contracts the task,
an external expenditure management block configured to subtract points in accordance with an amount of payment from a predetermined account of a department that pays money to an external organization,
an external income management block configured to pay points in accordance with an amount of reception to an account of a department that receives money paid from an external organization,
a department evaluation block configured to evaluate a department on the basis of points computed by dividing a balance of a department account by the number of persons belonging to the department every predetermined period, and
a personal evaluation block configured to evaluate an employee on the basis of a balance of a personal account of the employee every predetermined period; and
wherein the terminal means is configured to enter at least one of an ordered task and a contracted task and points set in accordance therewith.

2. The personnel management system according to claim 1, wherein
the control means,
if points are paid from one of the department account and a personal account of an employee belonging to the department to a personal account of an employee belonging to another department, adds the points also to a department account of the department with which the personal account of the employee to which the points are paid is linked;
if points are paid from a personal account of an employee belonging to a department to a personal account of an employee belonging to another department, subtracts the points also from a department account of the department with which the paying personal account is linked; and
if point exchange takes place in any one of the cases, namely, between personal accounts of employees belonging to a department and between a personal account of an employee belonging to a department and a department account, does not change the department account of the department.

3. The personnel management system according to claim 1, wherein the points are virtual currency.
